(19) United States
(12) Patent Application Publication
(10) Pub. No.: US 2020/0384389 A1
(43) Pub. Date: Dec. 10, 2020

(54) FUEL STRAINER FOR AN IN-TANK FUEL PUMP

(71) Applicant: DELPHI TECHNOLOGIES IP LIMITED, St. Michael (BB)

(72) Inventors: David D. Kinney, Fenton, MI (US); Joseph R. Carlson, Royal Oak, MI (US)

(21) Appl. No.: 16/434,465

(22) Filed: Jun. 7, 2019

(51) Int. Cl. B01D 35/027; B01D 35/06; F02M 37/50

(52) U.S. Cl. CPC B01D 35/0273; F02M 37/50; B01D 35/06

(57) ABSTRACT

A fuel strainer includes a first panel of filtration media having a filtration media first layer and a filtration media second layer and a second panel of filtration media having a filtration media first layer and a filtration media second layer such that the filtration media second layer is between the filtration media first layer of the second panel of filtration media and the filtration media second layer of the first panel of filtration media such that an interior space is formed between the first panel of filtration media and the second panel of filtration media which receives fuel that passes through the first panel of filtration media and the second panel of filtration media. A magnet is captured between the filtration media first layer and the filtration media second layer of either the first panel of filtration media or the second panel of filtration media.

### TECHNICAL FIELD OF INVENTION

The present invention relates to a fuel strainer for an in-tank fuel pump, and more particularly to such a fuel strainer which includes a magnet.

### BACKGROUND OF INVENTION

Fuel tanks which hold a volume of fuel, for example gasoline or diesel fuel, to be supplied to an internal combustion engine of a motor vehicle are known to include an in-tank fuel pump which is submersed in the fuel. In order to protect the internal workings of the fuel pump from foreign matter, i.e. particulate matter such as dirt and rust, which may be present in the fuel, it is known to provide the in-tank fuel pump with a fuel strainer on an inlet of the fuel pump. One such fuel strainer is shown in U.S. Pat. No. 6,830,687 to Dockery et al., the disclosure of which is hereby incorporated by reference in its entirety. Such fuel strainers may be configured to prevent particles of about 40 microns and larger from passing therethrough to the in-tank fuel pump, although micron rating of the fuel strainer may be tailored to each application. However, ferrous foreign matter, for example resulting from rusting of the fuel tank or other fuel system components, may be present in the fuel and may be sufficiently small so as to pass through the fuel strainer and pass to the in-tank fuel pump. Furthermore, ferrous foreign matter that may be sufficiently large to be captured by the fuel strainer may tend to be captured in one localized area of the fuel strainer near the inlet of the fuel pump which can restrict fuel flow to the fuel pump. Chinese Utility Model CN 201826998 discloses a fuel strainer which includes a magnet to capture ferrous foreign matter, however, one embodiment incorporates the magnet as a frame of the fuel strainer which is complex and costly to implement. In another embodiment, the magnet is described only as disposed to the inlet neck of the fuel strainer without any practical way of implementation.

What is needed is a fuel strainer which minimizes or eliminates one or more of the shortcomings as set forth above.

### SUMMARY OF THE INVENTION

Briefly described, a fuel strainer for an in-tank fuel pump includes a first panel of filtration media having a filtration media first layer and a filtration media second layer; a second panel of filtration media having a filtration media first layer and a filtration media second layer such that the filtration media second layer is between the filtration media first layer of the second panel of filtration media and the filtration media second layer of the first panel of filtration media such that an interior space is formed between the first panel of filtration media and the second panel of filtration media which receives fuel that passes through the first panel of filtration media and the second panel of filtration media; a fuel strainer outlet fitting fixed to the first panel of filtration media which is configured to mate with a fuel pump inlet of the in-tank fuel pump to provide a path for fuel to flow from the interior space to the in-tank fuel pump; and a magnet captured between the filtration media first layer and the filtration media second layer of the first panel of filtration media or between the filtration media first layer and the filtration media second layer of the second panel of filtration media.

Another fuel strainer for an in-tank fuel pump includes a first panel of filtration media having a filtration media first layer and a filtration media second layer; a second panel of filtration media having a filtration media first layer and a filtration media second layer such that the filtration media second layer is between the filtration media first layer of the second panel of filtration media and the filtration media second layer of the first panel of filtration media such that an interior space is formed between the first panel of filtration media and the second panel of filtration media which receives fuel that passes through the first panel of filtration media and the second panel of filtration media; a fuel strainer outlet fitting fixed to the first panel of filtration media which is configured to mate with a fuel pump inlet of the in-tank fuel pump to provide a path for fuel to flow from the interior space to the in-tank fuel pump; and a magnet with an adhesive between the filtration media first layer of the first panel of filtration media or the filtration media first layer of the second panel of filtration media such that the adhesive bonds the magnet to the filtration media first layer of the first panel of filtration media or the filtration media first layer of the second panel of filtration media.

Another fuel strainer for an in-tank fuel pump includes a first panel of filtration media having a filtration media first layer and a filtration media second layer; a second panel of filtration media having a filtration media first layer and a filtration media second layer such that the filtration media second layer is between the filtration media first layer of the second panel of filtration media and the filtration media second layer of the first panel of filtration media such that an interior space is formed between the first panel of filtration media and the second panel of filtration media which receives fuel that passes through the first panel of filtration media and the second panel of filtration media; a fuel strainer outlet fitting fixed to the first panel of filtration media which is configured to mate with a fuel pump inlet of the in-tank fuel pump to provide a path for fuel to flow from the interior space to the in-tank fuel pump; and a magnet within the interior space and with an adhesive between the filtration media second layer of the first panel of filtration media or the filtration media second layer of the second panel of filtration media such that the adhesive bonds the magnet to the filtration media second layer of the first panel of filtration media or the filtration media second layer of the second panel of filtration media.

The fuel strainers as described herein allow for capture of ferrous foreign matter in a design which is simple and economical to produce and which maximizes effectiveness of the magnet while minimizing restriction of flow to the fuel pump inlet.

### BRIEF DESCRIPTION OF DRAWINGS

This invention will be further described with reference to the accompanying drawings in which:

FIG. 1 shows a portion of a fuel tank having an in-tank fuel pump with a fuel strainer in accordance with the present disclosure;

FIG. 2 is an isometric view of the fuel strainer in accordance with the present disclosure;

FIG. 3 is a cross-sectional view of a portion of the fuel strainer taken through section line 3-3 of FIG. 2;

FIG. 4 is a cross-sectional view of a portion of the fuel strainer taken through section line 4-4 of FIG. 2;

FIG. 5 is a cross-sectional view similar to FIG. 3, now showing another fuel strainer in accordance with the present disclosure; and

FIG. 6 is a cross-sectional view similar to FIG. 3, now showing another fuel strainer in accordance with the present disclosure.

### DETAILED DESCRIPTION OF INVENTION

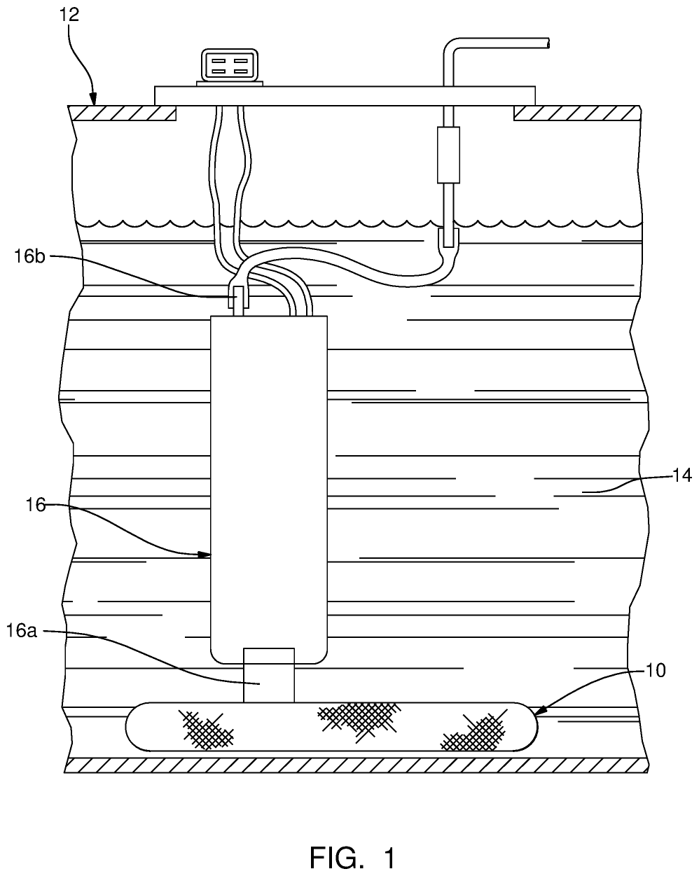

Referring initially to FIG. 1, a fuel strainer 10 is shown in a fuel tank 12 which holds a volume of fuel 14, by way of non-limiting example only, gasoline, alcohol, diesel fuel, ethanol, or blends containing one or more of the foregoing. Fuel tank 12 may be formed of metal or plastic in configurations that are known to those of skill in the art. Also within fuel tank 12 is an in-tank fuel pump 16 which includes a fuel pump inlet 16a through which in-tank fuel pump 16 draws fuel from volume of fuel 14 and also includes a fuel pump outlet 16b through which in-tank fuel pump 16 discharges fuel to be sent to a fuel consuming device, for example, an internal combustion engine (not shown). In-tank fuel pump 16 may be constructed, by way of non-limiting example only, in accordance with the disclosure of U.S. Patent Application Publication No. 2014/0314591 A1 to Herrera et al., the entire disclosure of which is incorporated herein by reference in its entirety. Fuel strainer 10 is attached to fuel pump inlet 16a such that fuel must pass through fuel strainer 10 before being drawn into in-tank fuel pump 16, thereby preventing foreign matter from being passed through in-tank fuel pump 16. While not shown, in-tank fuel pump 16 may be received within a fuel reservoir within fuel tank 12 as illustrated in U.S. Pat. No. 6,216,671 to Sawert et al., the disclosure of which is incorporated herein by reference in its entirety.

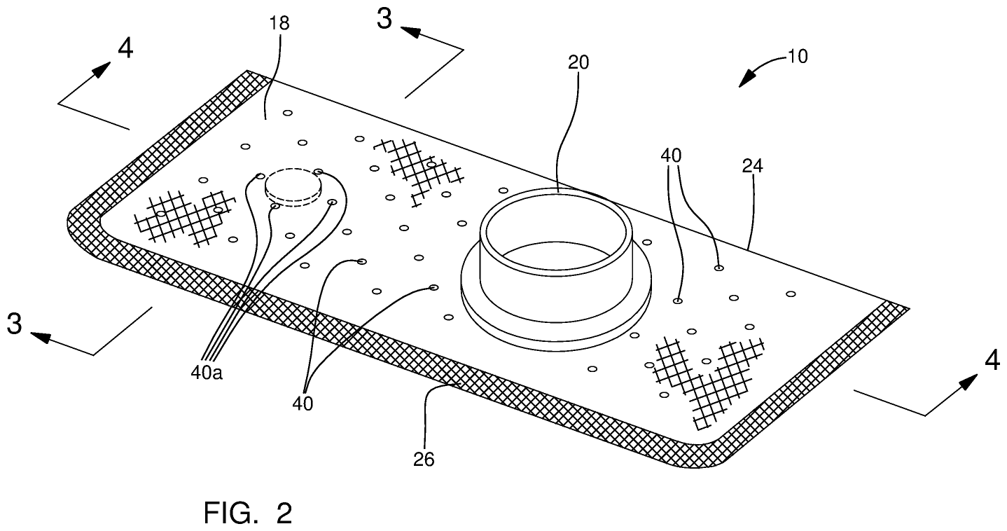

Now with reference to FIGS. 2-4, fuel strainer 10 will be described in greater detail. Fuel strainer 10 includes a first panel of filtration media 18 which includes a fuel strainer outlet fitting 20 fixed thereto which mates with fuel pump inlet 16a to provide a path for fuel to flow from fuel strainer 10 to in-tank fuel pump 16. Fuel strainer 10 also includes a second panel of filtration media 22 which is opposed to first panel of filtration media 18. First panel of filtration media 18 and second panel of filtration media 22 may be formed from a single, unitary sheet of filtration media which is folded over on itself, thereby causing first panel of filtration media 18 and second panel of filtration media 22 to be joined along one edge of the periphery of first panel of filtration media 18 and second panel of filtration media 22 by a fold 24. The remaining periphery of first panel of filtration media 18 and second panel of filtration media 22 are joined together at a seam 26 which may be produced by applying heat and compression which melts the remaining periphery of first panel of filtration media 18 and second panel of filtration media 22 together, thereby providing bonding and sealing. In one non-limiting alternative example, seam 26 may be formed by using adhesive to bond and seal the remaining periphery of first panel of filtration media 18 and second panel of filtration media 22 together. In another non-limiting alternative example, first panel of filtration media 18 and second panel of filtration media 22 may be separate pieces where the entire outer periphery of each includes seam 26 formed as described previously, and in this way, fold 24 may be omitted while keeping the entire outer periphery of first panel of filtration media 18 and second panel of filtration media 22 sealed to each other.

While the entire outer periphery of first panel of filtration media 18 and second panel of filtration media 22 are sealed to each other, i.e. by fold 24 and seam 26, the central portions of first panel of filtration media 18 and second panel of filtration media 22 are spaced apart from each other, thereby forming an interior space 28 between first panel of filtration media 18 and second panel of filtration media 22 which receives fuel that passes through first panel of filtration media 18 and second panel of filtration media 22. Fuel strainer outlet fitting 20 provides a path for fuel to flow from interior space 28 to in-tank fuel pump 16.

In order to maintain separation of first panel of filtration media 18 and second panel of filtration media 22, one or more separators 30 may be provided within interior space 28. Separators 30 are spaced apart from each other to allow flow of fuel therebetween. For convenience of formation, separators 30 may be integrally formed with one or more ribs 32 which provide rigidity to fuel strainer 10. By way of non-limiting example only, separators 30, ribs 32, and fuel strainer outlet fitting 20 may be formed in an injection molding process where first panel of filtration media 18 is placed into a mold cavity (not shown) and then a liquified thermoplastic such as nylon is injected into the mold cavity to form the features of separators 30, ribs 32, and fuel strainer outlet fitting 20. As illustrated herein, ribs 32 may be within interior space 28, however, ribs 32 may in addition to, or in the alternative, be formed on the exterior of fuel strainer 10. Furthermore, while separators 30 and ribs 32 have been illustrated herein as being fixed to first panel of filtration media 18, it should be understood that separators 30 and ribs 32 may alternatively be fixed to second panel of filtration media 22 or combinations of first panel of filtration media 18 and second panel of filtration media 22. Also furthermore, while separators 30, ribs 32, and fuel strainer outlet fitting 20 have been described herein as being formed in an injection molding operation with the filtration media in the mold, it should be understood that separators 30, ribs 32, and fuel strainer outlet fitting 20 may be formed separately and bonded to the filtration media with adhesives. It is also possible, particularly with separators 30 and ribs 32 that no bonding with the filtration media is required and they may be allowed to float within interior space 28, relying on geometry of the separators 30 and ribs 32 relative to fold 24 and seam 26 to limit movement thereof within interior space 28.

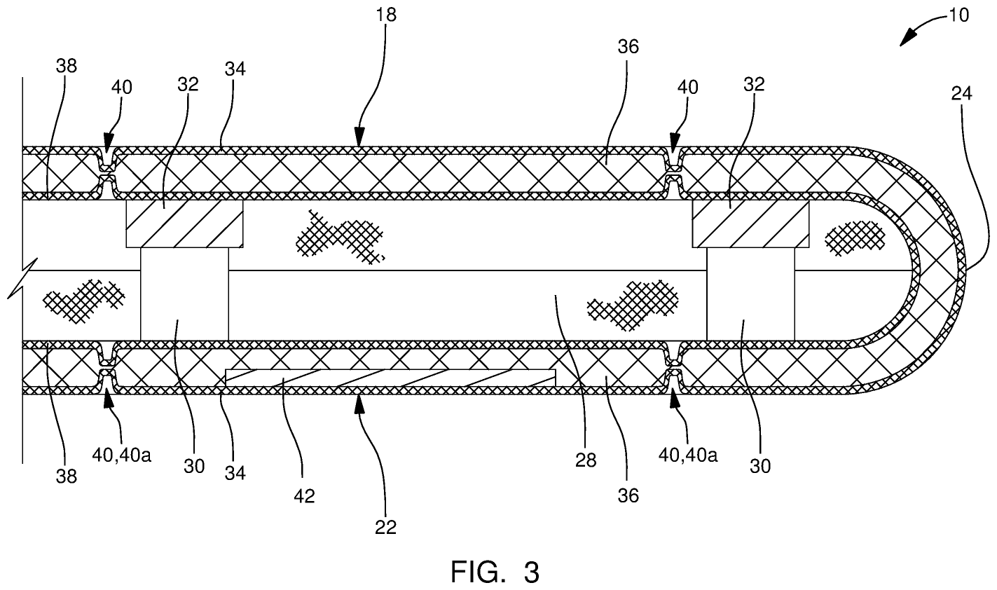

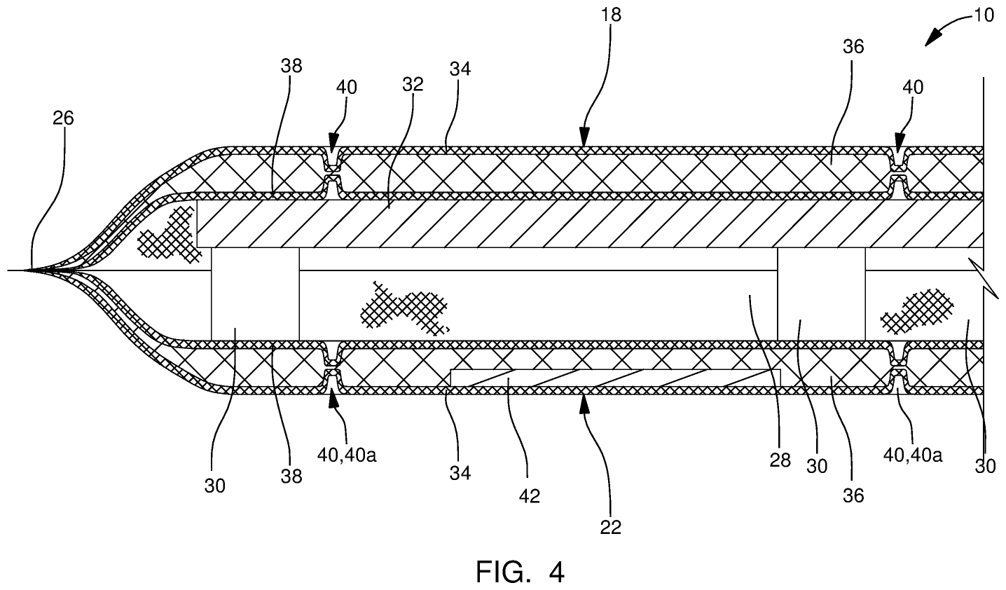

First panel of filtration media 18 and second panel of filtration media 22 will now be described in greater detail with respect to FIGS. 3 and 4. First panel of filtration media 18 and second panel of filtration media 22 may each be substantially the same in construction, and consequently, the construction of each will be described concurrently. First panel of filtration media 18 and second panel of filtration media 22 as illustrated herein each include three layers, although each having as few as two layers may be possible as well as each having more than three layers may be possible. The first layer is a filtration media outer layer 34 which is the outermost layer and which provides the exterior surface of fuel strainer 10. Filtration media outer layer 34 may be, by way of non-limiting example only, a non-woven material or mesh such as spun ponded nylon filaments or a nylon screen. The second layer, i.e. immediately adjacent to filtration media outer layer 34, is a filtration media central layer 36 which provides the majority of the filtration of fuel strainer 10, and may be, by way of non-limiting example only, a non-woven material such as spun bonded nylon filaments, however, the nylon filaments to produce filtration media central layer 36 are much finer than those used to produce filtration media outer layer 34 and are formed to provide filtration media central layer 36 with a thickness in the range of about 0.5 mm to about 2 mm or thicker in an uncompressed state. The third layer is a filtration media inner layer 38 which may be substantially similar to filtration media outer layer 34. As can be seen in the figures, filtration media inner layer 38 of first panel of filtration media 18 faces toward filtration media inner layer 38 of second panel of filtration media 22. U.S. Pat. No. 5,716,522 to Chilton et al., the disclosure of which is incorporated herein by reference in its entirety, provides additional details of exemplary materials for first panel of filtration media 18 and second panel of filtration media 22. However, it is important to note that numerous other materials for the various layers are known to those of ordinary skill in the art and may be used as alternatives, provided that at least one of first panel of filtration media 18 and second panel of filtration media 22 includes two layers. It is also important to note that the micron rating, i.e. the smallest particle which first panel of filtration media 18 and second panel of filtration media 22 are designed keep from passing therethrough may be selected based on the intended application where the typical micron rating is between about 40 microns and about 70 microns.

In order to keep filtration media outer layer 34, filtration media central layer 36 and filtration media inner layer 38 together, particularly prior to first panel of filtration media 18 and second panel of filtration media 22 being joined together, first panel of filtration media 18 and second panel of filtration media 22 may each be provided with a plurality of point-bonds 40 (only select point-bonds 40 have been labeled in the figures for convenience) at intervals across first panel of filtration media 18 and second panel of filtration media 22. As used herein, unless indicated otherwise, the term “across” refers to a direction that is perpendicular to the direction passing through the layers of first panel of filtration media 18 and second panel of filtration media 22. In other words, across refers to the direction of left and right and in and out of the page in FIGS. 3 and 4. Point-bonds 40 are formed by applying localized pressure and heat which locally melts one or more of filtration media outer layer 34, filtration media central layer 36 and filtration media inner layer 38, thereby causing first panel of filtration media 18 and second panel of filtration media 22 to remain compressed at point-bonds 40 after the heat and pressure are removed. In this way, filtration media outer layer 34, filtration media central layer 36 and filtration media inner layer 38 are fixed to each other. Point-bonds 40 also provide added rigidity to fuel strainer 10 and prevent movement of filtration media outer layer 34, filtration media central layer 36, and filtration media inner layer 38 relative to each other across a plane defined by sections lines 3-3 and 4-4 as shown in FIG. 2.

In order to capture ferrous foreign matter that may be within fuel tank 12, fuel strainer 10 includes a magnet 42. Of particular importance, magnet 42 is able to capture ferrous foreign matter that may be smaller than would be trapped by the filtration media of first panel of filtration media 18 and second panel of filtration media 22, thereby preventing the ferrous foreign matter from being ingested into in-tank fuel pump 16 where it could cause premature wear or other undesirable effects. Also of particular importance, magnet 42 is able to capture ferrous foreign matter at a location that minimizes restriction of flow to fuel pump inlet 16a. Magnet 42 is preferably a rare-earth magnet in order to maximize the strength thereof while minimizing its size. In one working example, magnet 42 was selected to be a Neodymium magnet, being cylindrical in form with a thickness of 1/16 inch and with a diameter of ½ inch, and being axially polarized, i.e. having its poles at opposing ends of magnet 42. In this example, the center of magnet 42 was positioned in a range of 50 mm to 60 mm from the center of fuel strainer outlet fitting 20 which maximized effectiveness. In contrast to expected results, effectiveness decreased when magnet 42 in this example was moved closer to the center of fuel strainer outlet fitting 20. In order to prevent corrosion of magnet 42, magnet 42 may include a coating which may be, by way of non-limiting example only, nickel.

Magnet 42 may be inexpensively incorporated into fuel strainer 10 by placing magnet 42 between filtration media outer layer 34 and filtration media inner layer 38, and more specifically, between filtration media outer layer 34 and filtration media central layer 36. Placement of magnet 42 between the outermost layer, i.e. filtration media outer layer 34, and closest adjacent layer, i.e. filtration media central layer 36, may be desirable because this minimizes the distance between magnet 42 and the exterior surface of fuel strainer 10, thereby maximizing the effectiveness of magnet 42. Furthermore, magnet 42 may preferably be placed within second panel of filtration media 22 as shown in the figures since second panel of filtration media 22 is proximal to the bottom of fuel tank 12 where foreign matter may tend to settle, thereby increasing the effectiveness of magnet 42. Since magnet 42 is placed between filtration media outer layer 34 and filtration media inner layer 38, retention of magnet 42 is ensured because fold 24 and seam 26 prevent magnet 42 from escaping. In order to ensure desired placement of magnet 42 within second panel of filtration media 22 at the most effective distance between centers of magnet 42 and fuel strainer outlet fitting 20, a series of point-bonds 40a are used to capture magnet 42 and movement of magnet 42 across second panel of filtration media 22. In other words, magnet 42 is placed to be surrounded by series of point-bonds 40a such that series of point-bonds 40a are spaced relative to the size of magnet 42 so as to prevent magnet 42 from moving outside of series of point-bonds 40a. It should be noted that series of points bonds 40a are hidden in FIG. 2, although due to scale, dashed lines indicating being hidden are not possible. In addition to, or in the alternative, an adhesive may be utilized to fix magnet 42 in position where the adhesive may be, by way of non-limiting example only, epoxy. While series of point-bonds 40a has been illustrated herein as including four point-bonds 40, it should be understood that different quantities may be used to capture magnet 42, and may be used together with seam 26 or fold 24 to limit movement of magnet 42 across second panel of filtration media 22.

While one magnet 42 has been illustrated herein as being included in second panel of filtration media 22, it should be understood that additional magnets 42 may be provided. Furthermore, while magnet 42 has been illustrated as being incorporated in second panel of filtration media 22, it should be understood that magnet 42 may alternatively be incorporated in first panel of filtration media 18. Still furthermore, it should be understood that both first panel of filtration media 18 and second panel of filtration media 22 may each include one or more magnets 42.

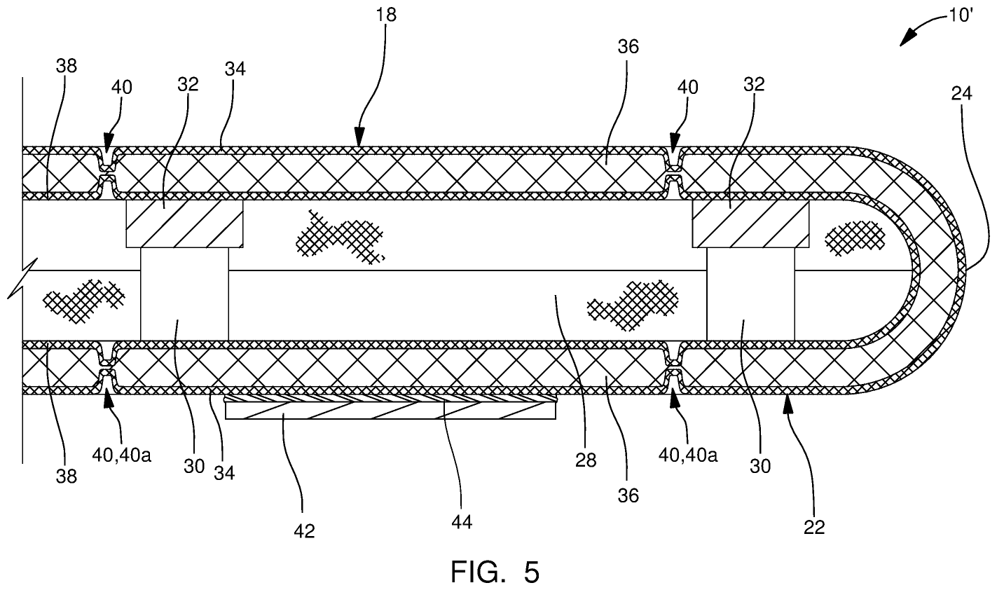

In an alternative illustrated in FIG. 5, a portion of a fuel strainer 10′ is illustrated. Fuel strainer 10′ is substantially the same as fuel strainer 10 except for the placement of magnet 42. Consequently, only the distinctions of fuel strainer 10′ will be described and like reference numbers in FIG. 5 correspond to the elements of reference numbers in FIGS. 2-4. In this arrangement, magnet 42 is located on the exterior of second panel of filtration media 22, i.e. outer surface of filtration media outer layer 34, and may be fixed there using an adhesive 44, which may be, by way of non-limiting example only, epoxy. In a further alternative, magnet 42 may be fixed to the outer surface of filtration media outer layer 34 of first panel of filtration media 18.

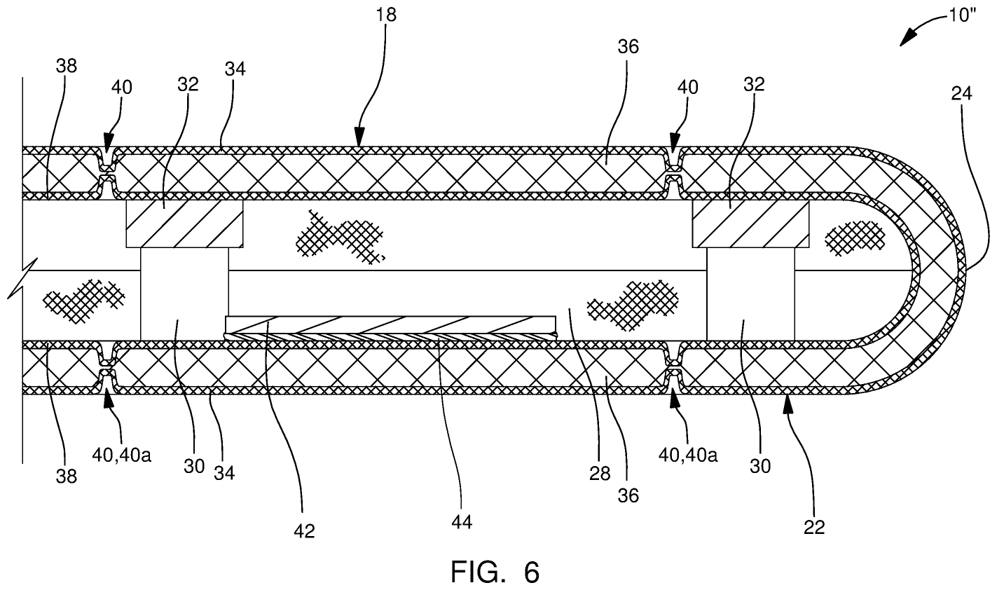

In another alternative illustrated in FIG. 6, a portion of a fuel strainer 10″ is illustrated. Fuel strainer 10″ is substantially the same as fuel strainer 10 and fuel strainer 10′ except for the placement of magnet 42. Consequently, only the distinctions of fuel strainer 10″ will be described and like reference numbers in FIG. 6 correspond to the elements of reference numbers in FIGS. 2-5. In this arrangement, magnet 42 is located within interior space 28 on the interior of second panel of filtration media 22, i.e. inner surface of filtration media inner layer 38, and may be fixed there using adhesive 44, which may be, by way of non-limiting example only, epoxy. In a further alternative, magnet 42 may be fixed to the inner surface of filtration media inner layer 38 of first panel of filtration media 18.

Fuel strainers 10, 10′, and 10″ as described herein allow for capture of ferrous foreign matter in a way which is simple an economical to produce and which maximizes the effectiveness of magnet 42. Furthermore, magnet 42 is positively positioned to remain in an effective position which collects the ferrous foreign matter in a location which minimizes restriction of fuel flow to fuel pump inlet 16a.

While this invention has been described in terms of preferred embodiments thereof, it is not intended to be so limited, but rather only to the extent set forth in the claims that follow.

1. A fuel strainer for an in-tank fuel pump, said fuel strainer comprising:
a first panel of filtration media having a filtration media first layer and a filtration media second layer;
a second panel of filtration media having a filtration media first layer and a filtration media second layer such that said filtration media second layer of said second panel of filtration media is between said filtration media first layer of said second panel of filtration media and said filtration media second layer of said first panel of filtration media such that an interior space is formed between said first panel of filtration media and said second panel of filtration media which receives fuel that passes through said first panel of filtration media and said second panel of filtration media;
a fuel strainer outlet fitting fixed to said first panel of filtration media which is configured to mate with a fuel pump inlet of said in-tank fuel pump to provide a path for fuel to flow from said interior space to said in-tank fuel pump; and
a magnet captured between said filtration media first layer and said filtration media second layer of said first panel of filtration media or between said filtration media first layer and said filtration media second layer of said second panel of filtration media;
wherein:
said first panel of filtration media includes a plurality of point-bonds at intervals across said first panel of filtration media such that said plurality of point-bonds fix said filtration media first layer of said first panel of filtration media to said filtration media second layer of said first panel of filtration media;
said second panel of filtration media includes a plurality of point-bonds at intervals across said second panel of filtration media such that said plurality of point-bonds fix said filtration media first layer of said second panel of filtration media to said filtration media second layer of said second panel of filtration media; and
a series of said plurality of point-bonds of said first panel of filtration media or of said second panel of filtration media limits movement of said magnet across said first panel of filtration media or across said second panel of filtration media.

2. (canceled)

3. The fuel strainer as in claim 1, wherein the center of said magnet is 50 mm to 60 mm from the center of said fuel strainer outlet fitting.

4. The fuel strainer as in claim 1, wherein said filtration media first layer of said first panel of filtration media is an outermost layer of said first panel of filtration media and wherein said filtration media first layer of said second panel of filtration media is an outermost layer of said second panel of filtration media.

5. The fuel strainer as in claim 4, wherein:
said filtration media second layer of said first panel of filtration media is immediately adjacent to said filtration media first layer of said first panel of filtration media; and
said filtration media second layer of said second panel of filtration media is immediately adjacent to said filtration media first layer of said second panel of filtration media.

6. The fuel strainer as in claim 1, wherein said magnet is a rare-earth magnet.

7-10. (canceled)

11. The fuel strainer as in claim 1, wherein said series of point-bonds of said first panel of filtration media or of said second panel of filtration media are spaced relative to a size of said magnet so as to prevent said magnet from moving outside of said series of point-bonds across said first panel of filtration media or across said second panel of filtration media.
